(19) United States
(12) Patent Application Publication
(10) Pub. No.: US 2006/0206353 A1
(43) Pub. Date: Sep. 14, 2006

(54) Method and system for intelligent queue management

(75) Inventors: Giovanni Buschi, Nice (FR); Beatrice Coulomb, Cagnes sur Mer (FR); Dimitris Gibault, Cagnes sur Mer (FR); Christophe Palaysi, Villeneuve Loubet (FR)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/369,673

(22) Filed: Mar. 7, 2006

(30) Foreign Application Priority Data
Mar. 8, 2005 (EP) 05300172.3

(51) Int. Cl. G06Q 99/00

(52) U.S. Cl. 705/1; 705/5

(57) ABSTRACT

A system and method for intelligent queue management uses a virtual destination locator to guide any queue members with pre-allocated final destination assignment. The guiding arranges the queue members into a sequence and then guides them to the final destination by moving the virtual destination location in accordance with the sequence.

### TECHNICAL FIELD OF THE INVENTION

The present invention is directed to queue management and in particular relates to a method and system for intelligent queue management, for example in aircraft, other vehicles or enclosures with only a limited number of entrances.

### BACKGROUND ART

Boarding an aircraft or similar type of vehicle is often tedious and slow. This is predominantly due to the fact that all the passengers must enter through a limited number of entrances often at one end of the vehicle. This invariably means that passengers seated near the entrance of the vehicle delay passenger further along the vehicles, whilst stowing bags and getting settled. See FIG. 1, where passenger 110 is preventing the progress of many other passengers 112 along the aisle 114.

Airline companies have attempted to mitigate some of the delays and congestion by calling out seat numbers and encouraging passengers to queue and load in accordance with certain constraints. However, the customers often fail to hear the instructions, arrive early or late or merely ignore the instructions.

Also if certain passengers take longer to board than others then the constraints will not avoid the congestion problems and may worsen delays. This means that the congestion problems are rarely avoided.

### OBJECT OF THE INVENTION

One object of the present invention is to overcome at least some of the problems of previous methods and systems of queue management so as to minimise delays for customers.

### SUMMARY OF THE INVENTION

The present invention is directed to the method and system as defined in the claims.

More particularly, the present invention discloses an intelligent queue management system for managing the entry of queue members through an entrance, the system comprising: means for identifying a plurality of queue members wherein each has an allocated final destination; mapping means for mapping each final destination onto a virtual destination location; guiding means for guiding each queue member, using the virtual destination location, towards the corresponding final destination in a predetermined manner; wherein the predetermined manner determines a sequence in which the queue members should pass through the entrance so as to not delay other queue members in the sequence as each moves to their respective final destinations.

This has the advantage that people or things that are queuing are guided in a controlled manner towards their final destination. The sequence in which they pass through the entrance being controlled to ensure that queue members can move to their final destination without being delayed by other queue members in front of them.

As the sequence can be adapted depending on the queue, where it is going, what and where the entrance is and so on the system can be used in a multitude of different situations.

More particularly the present invention discloses a method of managing the entry of queue members through an entrance, comprising the steps of: identifying a plurality of queue members each having an allocated final destination; mapping each final destination onto a virtual destination location; guiding each queue member, using the virtual destination location, towards the corresponding final destination by the steps of: determining a sequence in which the queue members should pass through the entrance; and controlling the queue members using the virtual destination locations so that each queue member does not delay other queue members in the sequence as each moves to their respective final destinations.

The virtual destination locations provide each queue member with something which can assist in directing and guiding the queue member to the final destination. Each final destination has a corresponding virtual destination location and the combination is maintained. This means that once the queue member has found the relevant virtual destination location which corresponds with queue member's final destination it is simply necessary for the queue member to follow the virtual destination location to be guided in a controlled manner and thus minimise delays.

Further embodiments of the invention are provided in the appended dependant claims.

### BRIEF DESCRIPTION OF THE DRAWINGS

Reference will now be made by way of example to the accompanying drawings in which:

FIG. 1 is a diagram showing the problem of congestion in vehicles with limited means of entry.

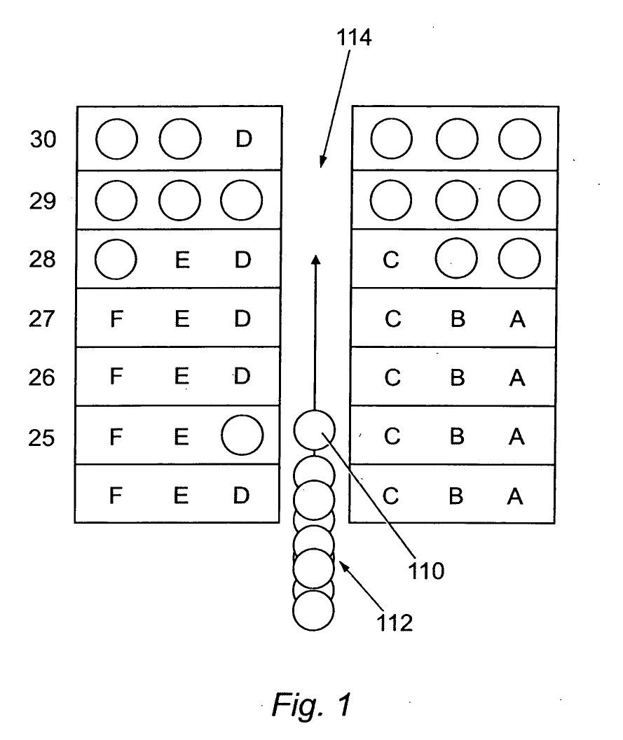

FIG. 2 is a diagram of system architecture according to one aspect of the present invention.

FIG. 3 is a schematic diagram for showing progress of passengers using the queue management system of FIG. 2.

FIG. 4 is a plan diagram of the floor in a departure lounge for showing how the system overcomes congestion problems.

FIG. 5 is a flow chart of the process steps performed by the queue management system.

### DESCRIPTION OF AN EMBODIMENT OF THE INVENTION

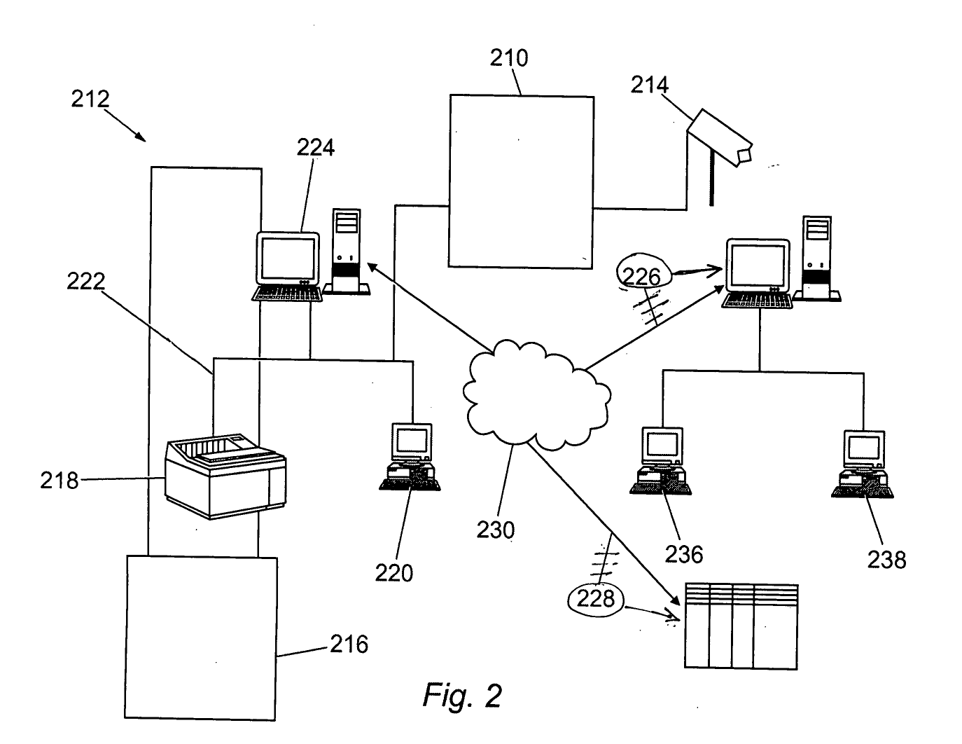

Referring initially to FIG. 2 an intelligent boarding or guidance system (IBS) 210 according to the present invention is shown as part of an aircraft boarding system (shown generally as 212). The IBS is connected to a means for displaying a virtual seating plan 214, for example on to the floor in front of a boarding gate 216.

The boarding gate includes an automatic ticket machine 218 and also a computer 220. The ticket machine 218 and the computer 220 are connected via an Ethernet connection 222 to the IBS and also to a gateway 224.

The gateway is used to access maintenance 226 and the airline host 228 via a network 230. In this case the network is an internet protocol (IP) network. The maintenance connection may include a gateway (not shown) with Ethernet connections (not shown) to management and operational servers 236 and 238 respectively. The connection to the airline host may connect in any appropriate manner.

The connection to maintenance and airline hosts are shown by way of example, and indicate the airline host information and maintenance information may be passed to both the boarding gate and the IBS to assist update of the system to optimise boarding. In addition, it should be noted that the boarding system 212 may include more, less or different linkages depending on the type of vehicle being boarded, or other variable parameter which may influence such a boarding system.

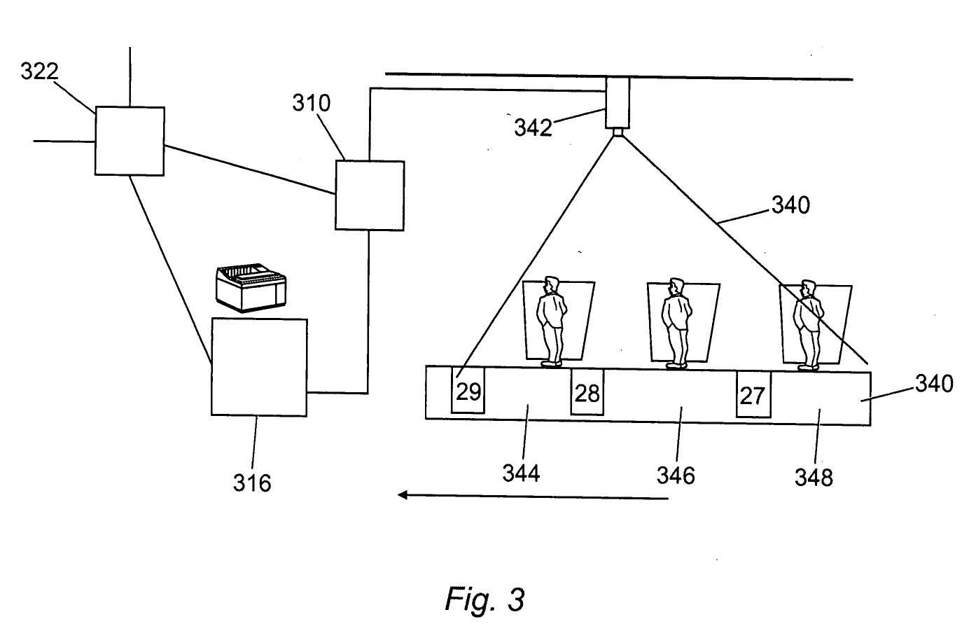

Referring now to FIG. 3 the way in which the IBS 210 facilitates easy boarding will now be described. The IBS sends a virtual seating plan 340 to a projector 342. The virtual seating plan is displayed on the floor (not shown) of the boarding area close to the boarding gate 216.

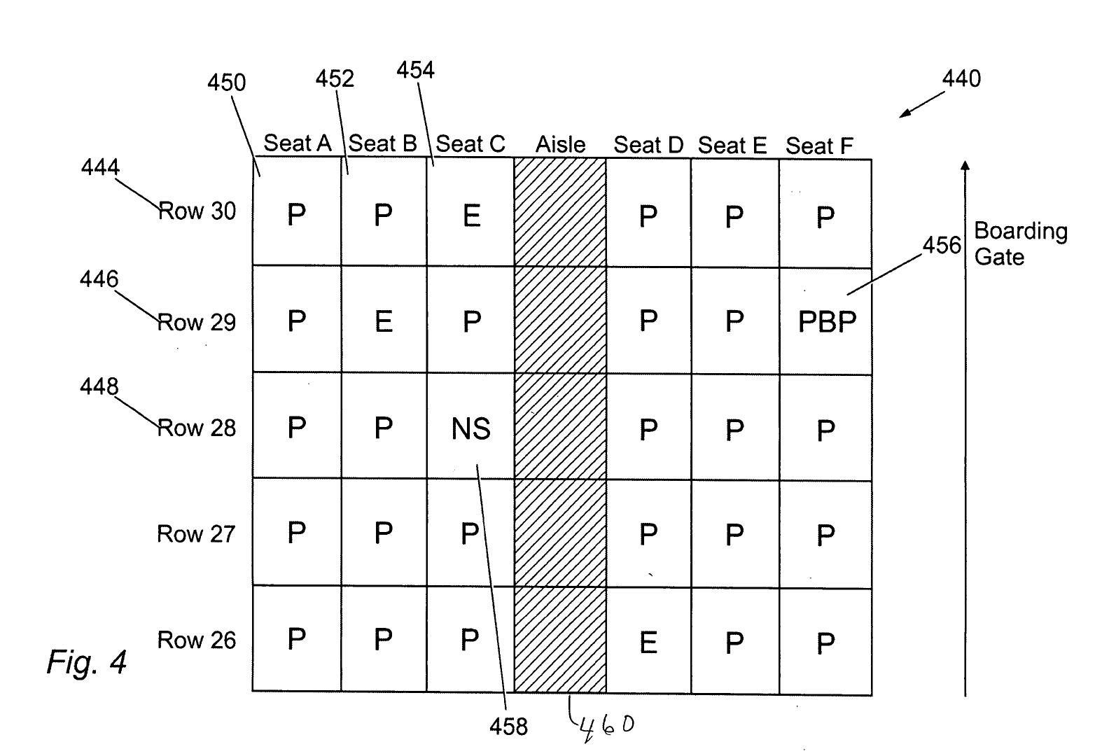

FIG. 4 shows a typical display of the virtual seating plan 340 or 440 that may be seen on the floor and will be described in greater detail below.

Referring again to FIG. 3 a number of rows of passengers 344, 346 and 348 are displayed. The row of passengers 344 are the first passengers to pass through the boarding gate. This row of passengers corresponds to farthest row back in the aircraft. Once all the allocated passengers from row of passengers 344 have passed through the boarding gate, the boarding agent activates an IBS update. When the IBS updates it activates the projector to update the floor plan so that the next row 346 is at the front of the queue and a new row (not shown) is added to the back of the queue. The passengers then more forward one row on the virtual seat plan and await the next update or pass through the boarding gate as appropriate.

Referring now to FIG. 4, the virtual seat plan 440 is shown in greater detail. The seat plan includes a number of rows 444, 446, 448 which correspond to 344, 346 and 348 respectively in FIG. 3. Also seats A to F are shown for each row and a code is shown for each seat in each row. The codes shown in FIG. 4 are merely by way of example and other codes, colours, symbols etc may be used as appropriate.

Seat 30A indicated as 450 and Seat 30B indicated as 452 each show code P. Code P means a passenger has checked-in at the check-in desk and should be in the boarding area awaiting boarding. Seat 30C indicated as 454 shows code E. This code means that the seat is empty and not being used on this journey. Seat 29F indicated as 456 shows the code PBP. This means that the passenger is a pre-board passenger and has already boarded. Details of pre-boarding will be described in greater detail below. Seat 28C indicated as 458 shows the code NS. This code means that a passenger has paid for a seat but has not yet checked in at the check-in desk. The NS code can only be displayed if the check-in desk is still open. Once the check-in desk closes any NS codes are automatically updated to E. The virtual seat plan also shows aisle 460.

As previously indicated once the first row of passengers 444 has boarded the virtual seat plan is updated and instead of showing aircraft rows 30-26 will show aircraft rows 29-25. Similarly when the next row of passengers 446 has passed the boarding gate the virtual plan will show aircraft rows 28-24, and so on.

There may be a number of passengers for a given flight which are identified as having special needs with regards to boarding. For example, the elderly or infirm, families with young children, children travelling alone etc. These passengers may be selected to pre-board. If this is the case the seat number of these passengers will be identified at check in by use of the code PBP or some other identifier. If pre-boarding passengers are identified by the IBS when boarding commences the IBS will activate the projector to display a pre-boarding virtual seat plan. This will be displayed and the process completed before the row by row boarding process commences.

The virtual seat plan of FIGS. 3 and 4 will clearly vary dependant on the type of aircraft or other vessel being boarded. In addition, it is expected that this invention will be most useful for boarding passengers on large vehicles for example the Airbus™, 380. Also it is anticipated that this invention may also be useful in organising and managing the queuing of other things. For example, cars coming to a toll, customers at the theatre or a retail outlet check out and many other queuing situations.

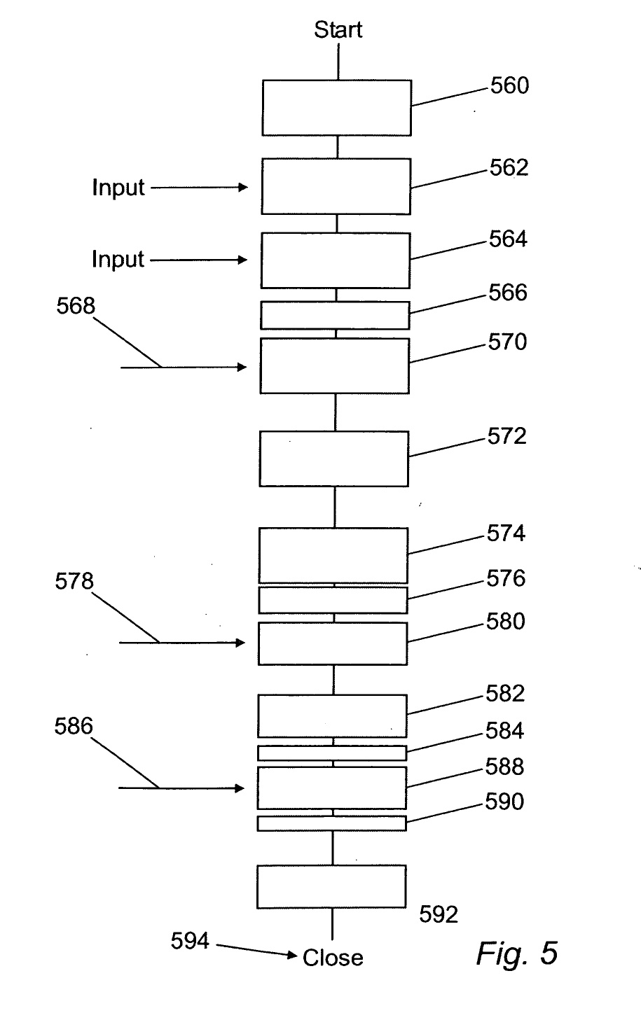

Reference will now be made to FIG. 5 which is a flow chart displaying the essential steps of the queuing or boarding process carried out by the IBS.

The routine starts when a flight check-in opens 560.

Details of aircraft type 562 and the intended seating plan 564 for this flight are entered into the IBS by suitable means. For example, all details of aircraft type and seating plan are stored and accessed using a look up table linked to the airport systems.

At check in 566, the customer presents a ticket for the flight and after the normal security processes a boarding pass is issued by a check-in agent. The boarding pass indicates the allocated seat for that passenger based on the seating plan. If the passenger has any special needs which might indicate a need to pre-board this will be marked on the passenger information and details stored by the check-in agent.

At an appropriate time the aircraft will be ready and boarding may commence 568. This information may come from any appropriate resource, such as maintenance for example.

Check-in data from the check-in system is downloaded to the IBS 570 either when boarding commences in one block, step wise as each passenger checks in or a combination of the two.

The following optional steps may then be carried out. If the airline permits pre-boarding and there are passengers identified for pre-boarding the relevant passengers are identified 572. The seating plan 574 is then displayed on the floor of the boarding area and pre-boarding passengers are invited to take their places on the virtual seating plan. The passengers will then be allowed to board through the normal boarding process 576. When pre-boarding is complete the attendant will provide an input 578 to the IBS. The IBS will then start the normal row by row boarding process 580.

The IBS causes the virtual seat plan to be displayed showing rows n to rows m 582. The numbers n and m will depend on the type of aircraft and the size of the virtual seating plan which is displayed. Row n is then boarded 584. When everyone in row n has passed through the boarding gate the attendant or the system may update the IBS 586.

The IBS then causes the virtual seating plan to be amended to show row (n-1) to row (m-1), 588. Row (n-1) is then boarded 590.

The update of the IBS and next row boarding then continues until all passengers have boarded and at this point the system is closed.

The attendant inputs to the system may be generated automatically by the boarding card reader or by other appropriate means. However, there will be a need for attendant inputs if passengers on the virtual seat plan are late or other problems arise. This will ensure that unnecessary delays are avoided.

The system described above discloses a projector which displays the virtual seat plan onto the floor. There may be other ways to achieve the same functionality, including screens on the floor and no projector, three dimensional imaging, lights et cetera.

The system has been described with reference to boarding an aircraft but is similarly relevant and adaptable to boarding trains, ferries and other vehicles. Also it can be useful in any situation where users have pre-issued tickets and arrive all at the same time to enter some sort of establishment. For example when visiting the cinema, a theatre, or a concert et cetera. It could also be possible to use a similar system to order and queue cars on a road, for example when coming up to a tollgate.

Clearly it will be obvious to the man skilled in the art that there are many variations of the invention which will still cover the basic principles of the invention and it is intended that these are included herein.

While the invention has been particularly shown and described with reference to a preferred embodiment, it will be understood that various changes in form and detail may be made therein without departing from the spirit and scope of the invention.

1. An intelligent queue management system (210) for managing the entry of queue members through an entrance, the system comprising:
means (210, 212, 220, 228) for identifying a plurality of queue members each has an allocated final destination(566);
mapping means for mapping each final destination (30A, 30B)onto a virtual destination location (574, 582, 588);
guiding means (340, 440)for guiding each queue member, using the virtual destination location (450, 452, 454, 456, 458), towards the corresponding final destination in a predetermined manner;
wherein the predetermined manner determines a sequence (440) in which the queue members should pass towards their final destination so as to not delay other queue members in the sequence as each moves to their respective final destinations (582, 584, 588, 590).

2. The system of claim 1, wherein the allocated final destination is a seat number (30A, 30B) and the virtual destination location is a representation (450, 452) of a virtual seat.

3. The system of claim 1 or claim 2, wherein the guiding means include a display visible (440, 340) to the queue member which moves in accordance with the sequence and which the queue member can follow to be guided to the final destination (30A, 30B).

4. The system of any preceding claim, wherein the final destinations of each queue member can be combined to form a seating plan (30A, 30B, etc)and the virtual destination locations can be combined to form a virtual seating plan (340, 440), which corresponds to some, or all, of the seating plan.

5. The system of any preceding claim, wherein the sequence in which the queue members pass through the entrance is a row by row sequence (576, 584, 590) where the rows enter in accordance with: farthest from the entrance first and nearest to the entrance last.

6. The system of claim 5, wherein the display shows row n to row m (582), where n is the row which has not yet passed through the entrance and which is farthest from the entrance and row m is a row further towards the entrance than row n; and wherein when row n has passed through the entrance (584)the display is updated to show row (n-1) to row (m-1) (588).

7. The system of any preceding claim, wherein the guide means include a display (214, 342) which displays the virtual destination location on the ground.

8. A method of managing the entry of queue members through an entrance, comprising the steps of:
identifying a plurality of queue members each having an allocated final destination (566);
mapping each final destination onto a virtual destination location (574, 582, 588);
guiding each queue member (340, 440), using the virtual destination location (450, 452, 454, 456, 458), towards the corresponding final destination in a predetermined manner;
wherein the predetermined manner comprises the steps of:
determining a sequence (440, 340) in which the queue members should pass through the entrance;
controlling the queue members using the virtual destination locations (582, 584, 588, 590) so that each queue member does not delay other queue members in the sequence as the or each moves to their respective final destinations.

9. The method of claim 8, further comprising identifying the final destination as a seat number (30A, 30B,etc) and representing the virtual destination location as a virtual seat (450, 452).

10. The method of claim 8 or claim 9, wherein the guiding step includes displaying a display visible to the queue member 342, 214), moving the display in accordance with the sequence (582, 588) and thereby guiding the queue member towards the final destination.

11. The method of claim 11, further comprising representing the final destinations of all queue members in the form a seating plan 30A, 30B, etc) and combining some, or all, of the virtual destination locations to form a virtual seating plan (340, 440), which corresponds to some, or all, of the seating plan.

12. The method of any claims 8 to 11, further comprising guiding the queue members through the entrance is a row by row sequence where the rows enter in accordance with: farthest from the entrance first and nearest to the entrance last.

13. The method of claim 12, further comprising the steps of:
displaying row n to row m (582), where n is the row which has not yet passed through the entrance and which is farthest from the entrance and row m is a row further towards the entrance than row n;
guiding row n through the entrance (584);
displaying row (n-1) to row (m-1) (588);
guiding row (n-1) through the entrance (590);
repeating these steps until all rows have passed through the entrance.

14. The method of any claims 8 to 13, wherein the guide means include a display (214, 342) which displays the virtual destination location on the ground.

15. A computer program comprising instruction for carrying out the steps of the method according to any one of claims 8 to 14, when said computer program is executed on a computer system.
